(19) United States
(12) Patent Application Publication
(10) Pub. No.: US 2025/0175206 A1
(43) Pub. Date: May 29, 2025

(54) TRANSMISSION/RECEPTION MODULE OF A VEHICLE

(71) Applicant: Continental Automotive Technologies GmbH, Hannover (DE)

(72) Inventors: Maximilian Klopfer, Kiefersfelden (DE); Steffen Kohlhepp, Rosenheim (DE)

(73) Assignee: Continental Automotive Technologies GmbH, Hannover (DE)

(21) Appl. No.: 18/954,916

(22) Filed: Nov. 21, 2024

(30) Foreign Application Priority Data
Nov. 24, 2023 (DE) 10 2023 211 729.0

(51) Int. Cl. H04B 1/3822; H04B 1/40; H04W 52/10

(52) U.S. Cl. CPC H04B 1/3822; H04B 1/40; H04W 52/10

(57) ABSTRACT

The disclosure relates to a transmission/reception module of a vehicle that comprises a transmission/reception unit for radio-frequency signals, an amplifier unit, which is connected downstream of the transmission/reception unit by means of a cable connection, and at least one antenna configured to relay a radio-frequency transmission signal and to receive a radio-frequency received signal. The disclosure provides for the amplifier unit to be a second control loop of the transmission/reception module (in addition to the known control loop) and, to this end, to comprise a variable amplifier, as the control element of the second control loop, to regulate the output power of the radio-frequency transmission signal relayed by the at least one antenna, as the controlled variable of the second control loop.

### BRIEF DESCRIPTION OF THE DRAWINGS

An exemplary embodiment of the disclosure is described in more detail below with reference to the drawing. In this regard,

FIG. 1 shows a block diagram of an exemplary transmission/reception module with the system components of the transmission/reception module; and

FIG. 2 shows an alternative block diagram of the exemplary transmission/reception module with the control components of the transmission/reception module.

### DETAILED DESCRIPTION

The disclosure relates to a transmission/reception module of a vehicle.

Increasingly certain functions of the vehicle are controlled using telematics. Telematics connect the vehicles, for example, to the cloud, to an emergency center in the event of an accident, or to a traffic management system to control the flow of traffic.

For these applications, radio-frequency signals are often used for the vehicle's communication within the context of what is known as a V2X communication (vehicle to everything communication). To this end, at least one antenna of a transmission/reception module of the vehicle relays radio-frequency transmission signals as a transmitted message and/or at least one antenna of the transmission/reception module of the vehicle receives radio-frequency received signals as a received message. To ensure sufficient transmission power for the radio-frequency transmission signals relayed by the at least one antenna of the transmission/reception module of the vehicle, or in particular also to compensate for attenuation losses due to cable connections inside of the transmission/reception module, the radio-frequency transmission signals generated by a transmission/reception unit of the transmission/reception module are normally amplified by means of an amplifier unit of the transmission/reception module prior to being relayed.

In this regard, US 2012/0177095 A1 discloses a method in which an orthogonal frequency-division multiplexing method, that is to say a modulation method in which multiple orthogonal carrier frequencies are used for digital data transmission, is intended to involve, during the acquisition phase for signals in certain reception channels, a reduction of interference from adjacent reception channels. This is accomplished by selecting the RF gain based on the total energy formed as the sum of the received energies in the individual reception channels. More specifically, the RF gain is also appropriately adapted when signal reception is detected in a reception channel, to largely suppress interference with adjacent reception channels.

The subject matter of the disclosure is based on the object of specifying a transmission/reception module of a vehicle which easily permits advantageous and improved selection of the power level at the output of the transmission/reception module.

According to the disclosure, the transmission/reception module of a vehicle comprises an amplifier unit, which is arranged upstream of the at least one antenna configured to relay radio-frequency transmission signals and to receive radio-frequency received signals, as a signal amplifier, said amplifier unit being a second control loop of the transmission/reception module having a variable amplifier, as the control element of the second control loop, and intended to regulate the power level of the output power of the radio-frequency transmission signal relayed by the at least one antenna, as the controlled variable of the second control loop. The “first control loop” may come from a known solution or may be the variant of the “first control loop” that is described later on.

Radio-frequency signals, in other words radio-frequency transmission signals and radio-frequency received signals, often relate to a frequency range between 100 kHz and 300 GHz and may be used in to transmit power and/or information over long distances.

In one advantageous development according to the disclosure, the variable amplifier of the amplifier unit is an attenuation selector having variable power attenuation and a power amplifier having constant power gain which interacts with the attenuation selector. More specifically, the power amplifier having constant power gain may be connected downstream of the attenuation selector having variable power attenuation in this instance.

In a first preferred embodiment, the at least one antenna configured to relay radio-frequency transmission signals is integrated in the amplifier unit and in this instance arranged at the amplifier output of the amplifier unit. A specific power level for the output power of the radio-frequency transmission signal is applied to the at least one antenna at the amplifier output of the amplifier unit.

In an alternative preferred embodiment, the at least one antenna configured to relay radio-frequency transmission signals is connected to the amplifier output of the amplifier unit via a (short) cable connection and is therefore arranged separately from the amplifier unit. Here, a specific power level for the output power of the radio-frequency transmission signal is applied to the at least one antenna via the (short) cable connection.

In an initialization phase of the transmission/reception module, after the transmission/reception module is switched on, the power level of the output power of the radio-frequency signal is adjusted to a defined power level by the amplifier unit, as the second control loop of the transmission/reception module. That is to say that the control by the amplifier unit, as the second control loop of the transmission/reception module, is active in the initialization phase of the transmission/reception module after the transmission/reception module is switched on.

Preferably, the amplifier unit, as the second control loop of the transmission/reception module, regulates the power level of the output power of the radio-frequency transmission signal to a defined power level based on the signal attenuation, which is dependent on the cable length of the cable connection between the transmission/reception unit and the amplifier unit. More specifically, the power level of the output power of the radio-frequency transmission signal is regulated based on the minimum possible signal attenuation, which is dependent on the cable length of the cable connection between the transmission/reception unit and the amplifier unit.

Following the initialization phase of the transmission/reception module, the output power of the radio-frequency transmission signal is adjusted to a defined power level by the amplifier unit, as the second control loop of the transmission/reception module, in the operating phase of the transmission/reception module only inside of a specific control window for the output power of the radio-frequency transmission signal. Outside of this control window, the output power of the radio-frequency transmission signal, or the power level of the output power of the radio-frequency transmission signal, is not regulated by the amplifier unit, as the second control loop of the transmission/reception module. That is to say that the control by the amplifier unit, as the second control loop of the transmission/reception module, is not active outside of this control window.

Inside of the control window for the output power of the radio-frequency transmission signal, the controlled variable “output power of the radio-frequency transmission signal” can be regulated to a defined power level differently, according to the control difference for the output power of the radio-frequency transmission signal. That is to say that depending on the control difference between the target value and the actual value for the output power of the radio-frequency transmission signal, or for the power level of the output power of the radio-frequency transmission signal, a different step size is applied to the controller of the second control loop to compensate for the control difference.

Outside of the control window for the output power of the radio-frequency transmission signal, the output power of the radio-frequency transmission signal is adjusted to a defined power level by the transmission/reception unit, as the first control loop of the transmission/reception module, in the operating phase of the transmission/reception module. In this case, this first control loop of the transmission/reception module, which is connected upstream of the second control loop of the transmission/reception module, then also solely determines what power level for the output power of the radio-frequency transmission signal is output at the amplifier output of the transmission/reception module.

The transmission/reception module therefore comprises two control loops that regulate the output power of the radio-frequency transmission signal relayed by at least one antenna of the transmission/reception module to a desired power level. The transmission/reception unit, as the first control loop of the transmission/reception module, regulates the output power independently of the downstream amplifier unit, as the second control loop of the transmission/reception module. The amplifier unit, as the second control loop of the transmission/reception module, does not know the output power to be regulated of the first control loop; the maximum permissible power level of the output power of the radio-frequency transmission signal is used as the target value and therefore as the input variable for the amplifier unit, as the second control loop of the transmission/reception module.

As mentioned, the control difference is formed in the amplifier unit, as the second control loop of the transmission/reception module, only in a specific control window around the controlled variable acting as target value, and therefore only in a specific control window around the maximum possible, or maximum permissible, power level of the output power of the radio-frequency transmission signal. In an example, this control window for the controlled variable is 4 dB, and so the second control loop of the transmission/reception module uses the output power of the radio-frequency transmission signal as the controlled variable only in a range that diverges from the target value by +2 dB or −2 dB maximum. Outside of this control window, the amplifier unit, as the second control loop of the transmission/reception module, does not regulate the output power of the radio-frequency transmission signal.

Inside of the control window, as mentioned, the output power of the radio-frequency transmission signal, as the controlled variable, can be regulated in the amplifier unit, as the second control loop of the transmission/reception module, differently depending on the control difference. More specifically, a different step size to vary the controlled variable can be applied to the controller of the amplifier unit, as the second control loop of the transmission/reception module, according to the control difference between the actual value and the target value of the controlled variable.

The disclosure also contemplates combinations of the features of the described embodiments.

Advantageously, the transmission/reception module of a vehicle involves the power level of the output power of the radio-frequency transmission signal relayed by the at least one antenna being set to the maximum possible value in a wide range.

The exemplary embodiment explained below is a preferred embodiment of the disclosure. In the exemplary embodiment, the described components of the embodiment each constitute individual features that should be considered independently of one another, that each also develop the solution independently of one another and that should thus also be considered to be part of the solution individually or in a combination other than that shown. Furthermore, the embodiment described may also be supplemented by further features that have already been described.

In the figures, functionally identical elements are each provided with the same reference signs.

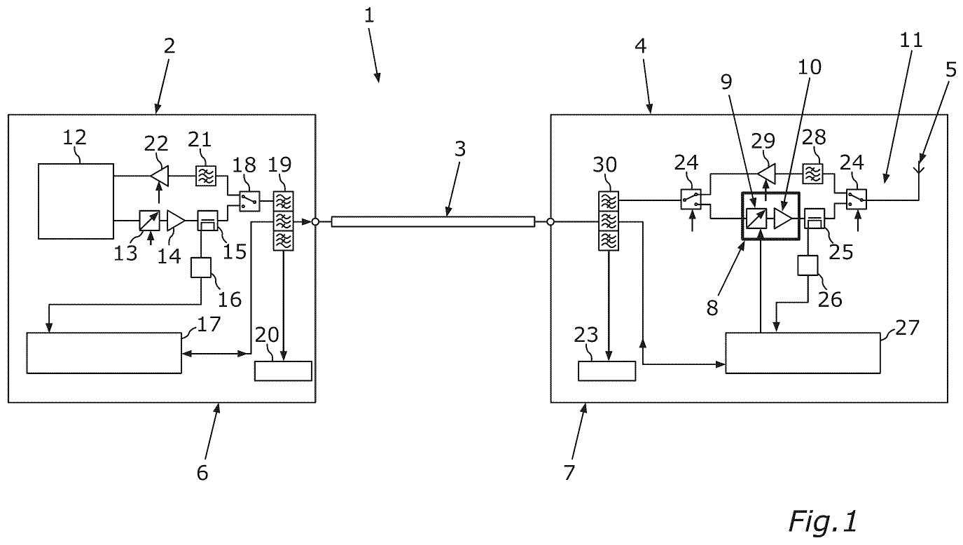

With reference to FIG. 1, the transmission/reception module 1 of a vehicle comprises a transmission/reception unit 2, often referred to as a telematics control unit (TCU), as the first control loop 6 of the transmission/reception module 1, an amplifier unit 4, which is connected downstream of the transmission/reception unit 2 and is often also referred to as a compensator unit, as the second control loop 7 of the transmission/reception module 1, and a cable connection 3 that is formed in the vehicle between the transmission/reception unit 2 and the amplifier unit 4. Depending on the positioning of the transmission/reception unit 2 and the amplifier unit 4 in the vehicle, this cable connection 3 can have a different cable length and therefore, depending on the cable attenuation, also bring about different signal attenuation of the radio-frequency transmission signal relayed by the transmission/reception module 1 of the vehicle.

To generate and receive radio-frequency signals of the transmission/reception module 1 and in particular also to regulate the power level of the output power of the radio-frequency transmission signal relayed by the transmission/reception module 1, the transmission/reception unit 2, as the first control loop 6 of the transmission/reception module 1 per FIG. 1, comprises the following circuit components, for example:
a transceiver 12 (transmitter and receiver) as an integrated circuit (IC) to transmit and receive V2X messages within the context of a V2X communication (vehicle to everything communication),
an attenuation selector 13 to vary, or to adjustably select, the output power of the transceiver 12,
a power amplifier 14, connected downstream of the attenuation selector 13, to amplify the transmitted messages of the V2X messages,
a coupler 15, connected downstream of the power amplifier 14, to decouple a small amount of the transmission power,
a level detector 16 that converts the transmission power of the radio-frequency transmission signal into a voltage value,
a controller 17 having multiple functions, such as voltage measurement of the voltage value of the voltage of the level detector 16, gain change, setup of a communication with the amplifier unit 4 and changeover between transmission mode and reception mode of the transmission/reception unit 2 and thus of the transmission/reception module 1,
a switch 18 to change over between transmission mode and reception mode of the transmission/reception unit 2 and thus of the transmission/reception module 1,
a filter 19 to combine the individual frequencies of the V2X messages on a common line,
a voltage regulator 20 to supply power to the transmission/reception unit 2,
a filter 21 to filter the received messages of the V2X messages in a specific frequency range,
and a low noise amplifier 22, connected upstream of the transceiver 12, that amplifies the received messages of the V2X messages.

To amplify the radio-frequency transmission signal relayed by the transmission/reception module 1 and in particular also to regulate the power level of the output power of the radio-frequency transmission signal relayed by the transmission/reception module 1 in a specific level range of the power level of the output power of the radio-frequency transmission signal relayed by the transmission/reception module 1, the amplifier unit 2, as the second control loop 6 of the transmission/reception module 1 per FIG. 1, comprises the following circuit components, for example:
a filter 30 that divides the frequencies of the V2X messages that have been combined on a common line by the filter 19 into the individual frequencies again,
a voltage regulator 23 to supply power to the amplifier unit 4,
two switches 24 to change over between transmission mode and reception mode of the amplifier unit 4 and thus of the transmission/reception module 1,
a variable amplifier 8 to vary the output power of the transmission/reception module 1 and thus the power level of the output signal of the transmission/reception module 1; to this end, the variable amplifier 8 consists of the attenuation selector 9 having variable power attenuation and the power amplifier 10 having constant power gain, which is connected downstream of the attenuation selector 9, to amplify the transmitted messages of the V2X messages,
a coupler 25, connected downstream of the power amplifier 10, to decouple a small amount of the transmission power,
a level detector 26 that converts the transmission power of the radio-frequency transmission signal into a voltage value,
a controller 27 having multiple functions, such as voltage measurement of the voltage value of the voltage of the level detector 26, gain change, setup of a communication with the transmission/reception unit 2 and changeover between transmission mode and reception mode of the amplifier unit 4 and thus of the transmission/reception module 1,
an antenna 5 configured to relay a radio-frequency transmission signal of the V2X messages at a specific transmission frequency,
a filter 28 to filter the received messages of the V2X messages in a specific frequency range,
and a low noise amplifier 29 that amplifies the received messages of the V2X messages.

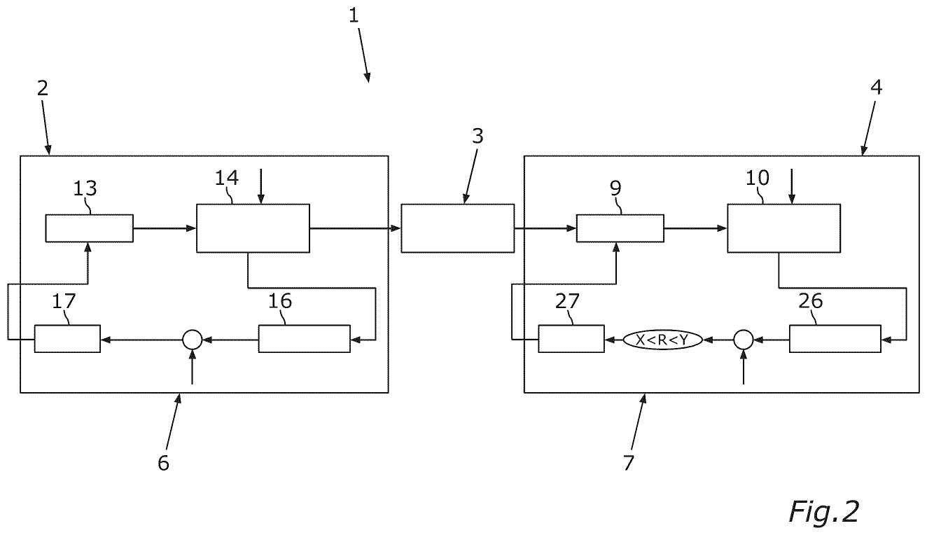

FIG. 2 schematically shows the components and parts of the two control loops 6, 7. The first control loop 6 of the transmission/reception module 1 is formed by the transmission/reception unit 2, and the second control loop 7 of the transmission/reception module 1 is formed by the amplifier unit 4.

The desired output power of the transmission/reception unit 2 of the transmission/reception module 1 during normal operation of the transmission/reception module 1 is a (maximum permissible) power level of, for example, 23 dBm, which is also meant to obtain under different operating conditions of the transmission/reception module 1 and with different interfering influences on the transmission/reception module 1. This is accomplished by using the amplifier unit 4 acting as a compensator, the action of which results in this maximum power level of, for example, 23 dBm also being present at the amplifier output of the amplifier unit 4 and thus on the antenna 5 of the transmission/reception module 1.

That is to say that the two control loops 6, 7 of the transmission/reception module 1 react independently of one another. In particular, the control by the transmission/reception unit 2, as the first control loop 6 of the transmission/reception module 1, is autonomous, and the control by the amplifier unit 4, as the second control loop 7 of the transmission/reception module 1, is meant to compensate for interference variables, such as the cable attenuation of the cable connection 3, or temperature influences, such as in particular on the gain of the power amplifiers 14, 10.

The controlled variable of the two control loops 6, 7 of the transmission/reception module 1 is the output power of the radio-frequency transmission signal relayed by the antenna 5 of the transmission/reception module 1, and thus the power level of this radio-frequency transmission signal that is meant to be adjusted to a desired power level of, for example, 23 dBm.

The transmission/reception unit 2, as the first control loop 6 of the transmission/reception module 1, regulates the output power of the radio-frequency transmission signal by virtue of the control element (attenuation selector 13) supplying a specific power attenuation, or gain, to the first controlled system (power amplifier 14) as a manipulated variable. Depending on specific interference variables, such as in particular temperature, which influences the power gain of the power amplifier 14, the controlled variable influenced by the latter is supplied at the output of the first controlled system to a measuring element (level detector 16), and this measuring element (level detector 16) determines the (instantaneous) actual value of the controlled variable “output power, or power level of the output power”. From a comparison of this actual value of the controlled variable “output power, or power level of the output power” and the predetermined target value of the controlled variable “output power, or power level of the output power”, the resultant difference between the target value and the actual value is supplied to the controller (controller 17) as a control difference. From this, the controller determines an updated control variable for the control element (attenuation selector 13), as a result of which a new attenuation value for the power attenuation is applied to the attenuation selector 13, as the control element.

Furthermore, the first control loop 6 of the transmission/reception module 1, and more specifically the first controlled system of the first control loop 6, is connected to the amplifier unit 4, as the second control loop 7 of the transmission/reception module 1, via a second controlled system. The second controlled system is formed in particular by a different cable attenuation of the cable connection 3 provided between the transmission/reception unit 2 of the transmission/reception module 1 and the amplifier unit 4 of the transmission/reception module 1.

The control in the amplifier unit 4, as the second control loop 7 of the transmission/reception module 1, works in a similar manner to the described control in the transmission/reception unit 2, as the first control loop 6 of the transmission/reception module 1.

The applicable components of the amplifier unit 4, as the second control loop 7 of the transmission/reception module 1, are the attenuation selector 9, as the control element, the power amplifier 10, as the third controlled system, the level detector 26, as the measuring element, and the controller 27, as the controller.

The amplifier unit 4, as the second control loop 7 of the transmission/reception module 1, uses the output power of the radio-frequency transmission signal, or the power level of the output power of the radio-frequency transmission signal, as the controlled variable. As mentioned, this power level of the output power of the radio-frequency transmission signal is for example 23 dBm maximum, and so the amplifier unit 4, as the second control loop 7 of the transmission/reception module 1, adjusts the output power of the radio-frequency transmission signal to this value of 23 dBm. To this end, the power level of the output power is measured at the output of the amplifier unit 4, as the second control loop 7 of the transmission/reception module 1, and is thus determined as the actual value of the controlled variable. This power level of the output power may be different depending on the cable attenuation of the connecting cable 3 and depending on the temperature, the temperature in particular changing the gain of the power amplifier 10 and thus the power level of the output power significantly.

This control by the amplifier unit 4, as the second control loop 7 of the transmission/reception module 1, is carried out in particular in the initialization phase of the transmission/reception module 1 after the transmission/reception module 1 is switched on. First, the gain factor (gain) of the variable amplifier 8 is chosen such that the predetermined minimum cable attenuation of the cable connection 3 is compensated for as a result. If this minimum cable attenuation of the cable connection 3 is, for example, 5 dBm, the gain factor (gain) of the variable amplifier 8 is also (first) set to 5 dBm by appropriately varying the attenuation factor of the attenuation selector 9.

In the operating phase of the transmission/reception module 1 that follows the initialization phase of the transmission/reception module 1, this control of the power level of the output power of the radio-frequency transmission signal is regulated by the amplifier unit 4, as the second control loop 7 of the transmission/reception module 1, only in a specific control window (X<R<Y) around the maximum permissible power level of the output power of the radio-frequency transmission signal of, for example, 23 dBm, for example in a control window between 21 dBm (X) and 25 dBm (Y).

Inside of said control window (X<R<Y) the amplifier unit 4, as the second control loop 7 of the transmission/reception module 1, can perform different regulation, specifically according to the control difference between the actual value and the target value of the power level of the output power, as the controlled variable. In particular, a different step size when varying the controlled variable can be applied to the controller 27 of the amplifier unit 4, as the second control loop 7 of the transmission/reception module 1, according to this control difference. By way of example, when the control difference between the actual value of the controlled variable and the target value of the controlled variable is between −2 dBm and −0.25 dBm, steps of 0.25 dB are applied to the controller 27 of the amplifier unit 4, as the second control loop 4 of the transmission/reception module 1, and thus the controller is regulated slowly, whereas a control difference of more than +1 dB between the actual value of the controlled variable and the target value of the controlled variable results in the controller 27 of the amplifier unit 4, as the second control loop 7 of the transmission/reception module 1, being regulated quickly.

Outside of said control window (X<R<Y), the control of the output power of the radio-frequency transmission signal is undertaken solely by the transmission/reception unit 2, as the first control loop 6 of the transmission/reception module 1. As a result, the power level of the output power of the radio-frequency transmission signal can also assume a value other than 23 dBm.

1. A transmission/reception module for a vehicle, the transmission/reception module comprising a transmission/reception unit for radio-frequency signals, having an amplifier unit, which is connected downstream of the transmission/reception unit by means of a cable connection, and having at least one antenna configured to relay radio-frequency transmission signals and to receive radio-frequency received signals, wherein the amplifier unit is a second control loop of the transmission/reception module having a variable amplifier, as a control element of the second control loop, to regulate output power of a radio-frequency transmission signal relayed by the at least one antenna, which output power is a controlled variable of the second control loop.

2. The transmission/reception module as claimed in claim 1, wherein the variable amplifier of the amplifier unit is an attenuation selector having variable power attenuation and is a power amplifier having constant power gain that interacts with the attenuation selector.

3. The transmission/reception module as claimed in claim 2, wherein the at least one antenna configured to relay radio-frequency transmission signals is arranged at an amplifier output of the amplifier unit in a manner integrated in the amplifier unit.

4. The transmission/reception module as claimed in claim 2, wherein the at least one antenna configured to relay radio-frequency transmission signals is connected to an amplifier output of the amplifier unit via a cable connection.

5. The transmission/reception module as claimed in claim 2, wherein in an initialization phase after the transmission/reception module is switched on the amplifier unit, as the second control loop, adjusts the output power of the radio-frequency transmission signal to a defined power level.

6. The transmission/reception module as claimed in claim 5, wherein in the initialization phase the amplifier unit, as the second control loop, adjusts the output power of the radio-frequency transmission signal to a defined power level based on signal attenuation, which is dependent on cable length of the cable connection between the transmission/reception unit and the amplifier unit.

7. The transmission/reception module as claimed in claim 5, wherein in the initialization phase the amplifier unit, as the second control loop, adjusts the output power of the radio-frequency transmission signal to a defined power level based on minimum possible signal attenuation, which is dependent on cable length of the cable connection between the transmission/reception unit and the amplifier unit.

8. The transmission/reception module as claimed in one of claims 5, wherein in an operating phase of the transmission/reception module that follows the initialization phase the amplifier unit, as the second control loop, adjusts the output power of the radio-frequency transmission signal to a defined power level only inside of a specific control window for the output power of the radio-frequency transmission signal.

9. The transmission/reception module as claimed in claim 8, wherein inside of the control window for the output power of the radio-frequency transmission signal the amplifier unit, as the second control loop, regulates the output power of the radio-frequency transmission signal differently according to control difference for the output power of the radio-frequency transmission signal.

10. The transmission/reception module as claimed in claim 8, wherein an output power of the radio-frequency transmission signal outside of the control window results in the transmission/reception unit, as a first control loop, connected upstream of the second control loop, of the transmission/reception module, adjusting the output power of the radio-frequency transmission signal to a defined power level in the operating phase of the transmission/reception module.

11. The vehicle comprising at least one transmission/reception module as claimed in claim 2.

12. The vehicle comprising at least one transmission/reception module as claimed in claim 1.

13. The transmission/reception module as claimed in claim 1, wherein the at least one antenna configured to relay radio-frequency transmission signals is arranged at an amplifier output of the amplifier unit in a manner integrated in the amplifier unit.

14. The transmission/reception module as claimed in claim 1, wherein the at least one antenna configured to relay radio-frequency transmission signals is connected to an amplifier output of the amplifier unit via a cable connection.

15. The transmission/reception module as claimed in claim 1, wherein in an initialization phase after the transmission/reception module is switched on the amplifier unit, as the second control loop, adjusts the output power of the radio-frequency transmission signal to a defined power level.

16. The transmission/reception module as claimed in claim 15, wherein in the initialization phase the amplifier unit, as the second control loop, adjusts the output power of the radio-frequency transmission signal to a defined power level based on signal attenuation, which is dependent on cable length of the cable connection between the transmission/reception unit and the amplifier unit.

17. The transmission/reception module as claimed in claim 15, wherein in the initialization phase the amplifier unit, as the second control loop, adjusts the output power of the radio-frequency transmission signal to a defined power level based on minimum possible signal attenuation, which is dependent on cable length of the cable connection between the transmission/reception unit and the amplifier unit.

18. The transmission/reception module as claimed in claim 15, wherein in an operating phase of the transmission/reception module that follows the initialization phase the amplifier unit, as the second control loop, adjusts the output power of the radio-frequency transmission signal to a defined power level only inside of a specific control window for the output power of the radio-frequency transmission signal.

19. The transmission/reception module as claimed in claim 18, wherein inside of the control window for the output power of the radio-frequency transmission signal the amplifier unit, as the second control loop, regulates the output power of the radio-frequency transmission signal differently according to control difference for the output power of the radio-frequency transmission signal.

20. The transmission/reception module as claimed in claim 18, wherein an output power of the radio-frequency transmission signal outside of the control window results in the transmission/reception unit, as a first control loop, connected upstream of the second control loop, of the transmission/reception module, adjusting the output power of the radio-frequency transmission signal to a defined power level in the operating phase of the transmission/reception module.
